(19) United States
(12) Patent Application Publication
(10) Pub. No.: US 2013/0324205 A1
(43) Pub. Date: Dec. 5, 2013

(54) GAME MONETIZATION METHOD AND SYSTEM

(71) Applicant: Yessenia Soffin, Boca Raton, FL (US)

(72) Inventor: Yessenia Soffin, Boca Raton, FL (US)

(21) Appl. No.: 13/794,167

(22) Filed: Mar. 11, 2013

Related U.S. Application Data
(60) Provisional application No. 61/652,988, filed on May 30, 2012.

(51) Int. Cl. G07F 17/32

(52) U.S. Cl. CPC G07F 17/3244
USPC 463/13; 463/25

(57) ABSTRACT

A game monetization method and system that monetizes a game, such as a virtual poker game, through the use of a digital image, such as an avatar. The digital image displays and utilizes a product or service integrated into the game by a company. A player plays the game with a preselected digital image. The player accrues credits by winning at the game, bartering, or purchasing credits with monetary funds. The credits are utilized to purchase a digital embodiment of a product and/or service from a virtual store. The digital image displays and/or utilizes the product and/or service during the game, so that the player views and listens to a marketing presentation of the product and/or service. A company can integrate the product or service into the game by paying an advertising fee. The company can also contact the player with additional marketing media.

### CROSS-REFERENCE TO RELATED APPLICATIONS

The present Utility patent application claims priority benefit of the U.S. provisional application for Ser. No. 61/652,988 entitled “A Method for Monetizing Free Online Gaming Websites Using Avatars”, filed on 30 May 2012, under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

The following related U.S. patent application, submitted by at least one of the present Applicant(s)/Inventor(s) is recently co-pending: U.S. utility patent application Ser. No. [TO BE DETERMINED], entitled “Conflict Monetization Method and System”, submitted to the United States Patent and Trademark Office (USPTO) on 11 Mar. 2013.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a game monetization method and system. More particularly, the invention relates to monetizing a game through avatars that display a product and/or service.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a game is a structured form of entertainment designed for the enjoyment of a player and generally incorporating goals, rules, challenge, interaction, and stimulation of the mind and body.

Typically, an online game is a video game played over some form of computer network, using a personal computer or video game console. This network is usually the internet or equivalent technology.

Typically, marketing is the process of communicating the value of a product or service to customers. Marketing may include the art of selling products. From a societal point of view, marketing is the link between a society's material requirements and its economic patterns of response. Marketing satisfies these needs and wants through exchange processes and building long term relationships.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate a flowchart diagram for an exemplary monetizing method that details the general interactions among an exemplary game administrator, an exemplary website, an exemplary product company, and an exemplary player, in accordance with an embodiment of the present invention, where FIG. 1A illustrates an exemplary player playing the game to accrue at least one credit used for obtaining a product or service, and FIG. 1B illustrates an exemplary administrator agreeing with a company to integrate the product or service into the game;

FIG. 2 illustrates an exemplary monetizing system, in accordance with an embodiment of the present invention;

FIG. 3 illustrates a flowchart diagram for an exemplary method for purchasing a product or service with an exemplary at least one credit, in accordance with an embodiment of the present invention;

FIG. 4 illustrates a flowchart diagram for an exemplary method for playing an exemplary poker game, in accordance with an embodiment of the present invention;

FIG. 5 illustrates an exemplary store that displays an exemplary product or service for purchase, in accordance with an embodiment of the present invention;

FIG. 6 illustrates an exemplary store that displays information for an exemplary product or service purchased with a at least one credit, in accordance with an embodiment of the present invention;

FIG. 7 illustrates an exemplary store that displays an exemplary product or service displayed for potential purchase, in accordance with an embodiment of the present invention;

FIG. 8 illustrates an exemplary store that displays an inventory of exemplary products or services purchased by an exemplary player, in accordance with an embodiment of the present invention;

FIG. 9 illustrates an exemplary digital image in the form of an exemplary avatar having a plurality of attributes available for selection, in accordance with an embodiment of the present invention;

FIGS. 10A and 10B illustrate an exemplary chat room in an exemplary game, in accordance with an embodiment of the present invention, where FIG. 10A illustrates an exemplary player communicating with other exemplary players through exemplary digital images, and FIG. 10B illustrates an exemplary player purchasing a product or service for other exemplary players from an exemplary virtual store;

FIGS. 11A and 11B illustrate an exemplary poker game between a plurality of players, in accordance with an embodiment of the present invention, where FIG. 11A illustrates an exemplary graphical depiction of exemplary digital images positioned around a poker table, and FIG. 11B illustrates an exemplary dialogue box inviting the exemplary player to pay an exemplary at least one credit to play the poker game;

FIGS. 12A, 12B, and 12C illustrate an exemplary poker game between a plurality of players, in accordance with an embodiment of the present invention, where FIG. 12A illustrates an exemplary virtual store displaying a plurality of exemplary products or services, FIG. 12B illustrates an exemplary digital image of an exemplary avatar with exemplary at least one credit and game history, and FIG. 12C illustrates an exemplary dialogue box inviting an exemplary player to purchase a at least one credit to play the poker game; and

FIG. 13 illustrates a block diagram of an exemplary computer system that, when appropriately configured or designed, may serve as an exemplary monetizing method and system, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer, a computer having a single processor, multiple processors, or multi-core processors, which may operate in parallel and/or not in parallel; a general purpose computer; a supercomputer; a mainframe; a super mini-computer, a mini-computer; a workstation; a micro-computer, a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

The present invention will now be described in detail with reference to embodiments thereof as illustrated in the accompanying drawings.

There are various types of monetizing methods and systems that may be provided by preferred embodiments of the present invention. In one embodiment of the present invention, the monetizing method and system may monetize a game through the use of a digital image that displays and utilizes a product or service integrated into the game by a company. A player may play the game with a preselected digital image configured to represent the player. The digital image may include, without limitation, a 3D avatar, a graphic, a logo, and a text. In some embodiments, the player may control the actions of the digital image during the game. The player may attempt to accrue a at least one credit while playing the game. In one embodiment, the at least one credit may be accrued or lost based on the performance of the player during the game. The credits may be utilized to purchase a digital embodiment of a product or service from a virtual store. However, in other embodiments, the at least one credit may be utilized to update various attributes and characteristics of the avatar. For example, without limitation, ten credits may purchase increased dexterity for an adventure game, or additional charisma for a poker game.

In one embodiment of the present invention, the digital image may display and utilize the product or service in a manner such that the player and/or additional players observe the digital image engaging with the product or service. Those skilled in the art, in light of the present teachings, will recognize that the player may observe the digital image utilizing the product or service. The observation of the digital image may include a visual or audio display of the product or service. For example, without limitation, a player may purchase a hat, and the player's avatar may then be shown wearing the hat. The digital image displaying the product or service may be configured to provide marketing for a company of the product or service. The marketing may include, without limitation, an advertisement, a jingle, a reminder, and a demonstration of the product or service being utilized.

In one embodiment of the present invention, an administrator may regulate the game. The administrator may contact a company to integrate the product or service produced by the company into the game. The company may pay a fee to integrate the product or service into the game. In this manner, the player may purchase the product or services with the at least one credit accrued, and then observe the digital image utilizing the product or service. Those skilled in the art, in light of the present teachings, will recognize that a connection between successful game playing and the product or service may be formed in the player's psyche. The player may have an affinity towards the digital image. For example, without limitation, the digital image may include a personalized avatar that extenuates the personality features of the player, e.g., an altar ego of the player. By obtaining the product or service through the successful game playing of the avatar, a psychological bond between the player and the product or service may form. Furthermore, the company may have a marketing platform to display the product or service to the player throughout the game.

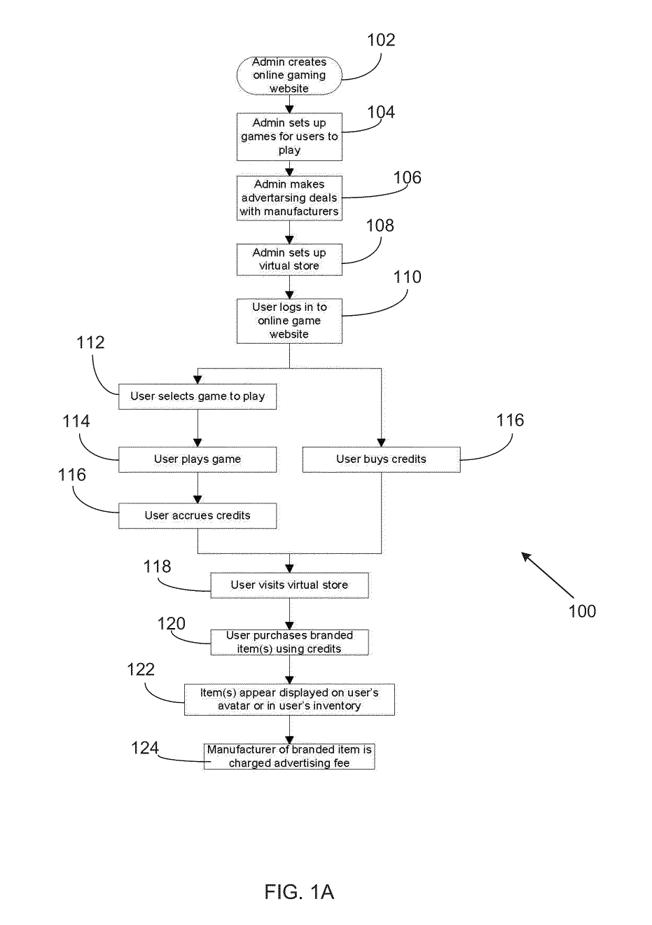

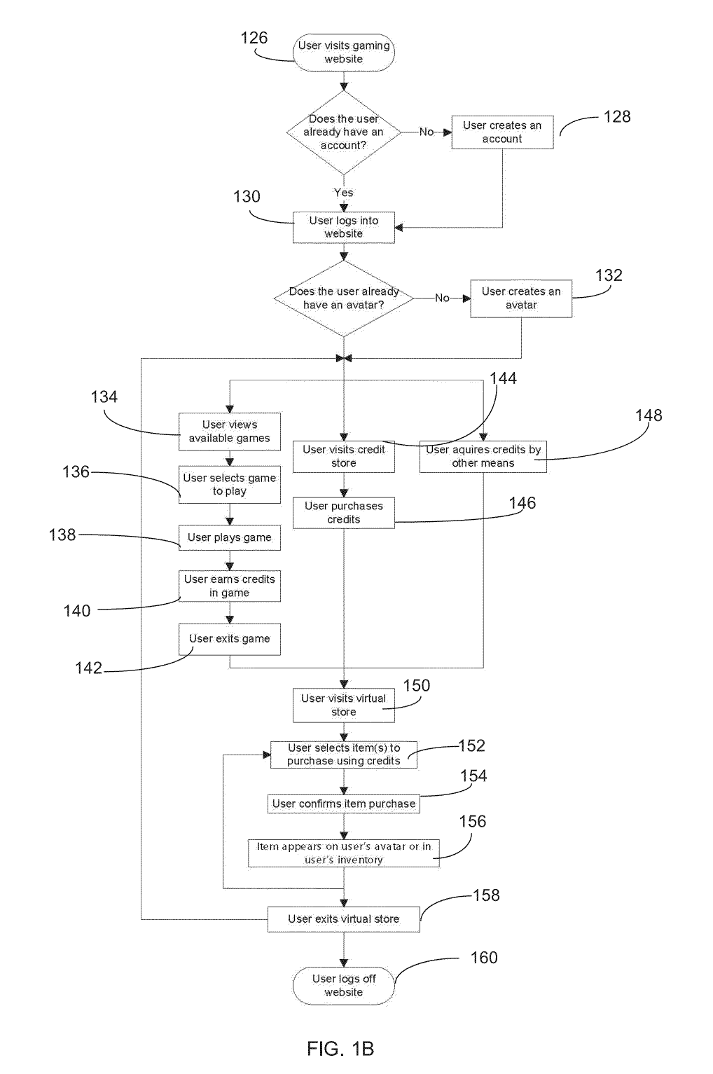

FIGS. 1A and 1B illustrate a flowchart diagram for an exemplary monetizing method that details the general interactions among an exemplary game administrator, an exemplary website, an exemplary product company, and an exemplary player, in accordance with an embodiment of the present invention, where FIG. 1A illustrates an exemplary player playing the game to accrue at least one credit used for obtaining a product or service, and FIG. 1B illustrates an exemplary administrator agreeing with a company to integrate the product or service into the game. In the present invention, a monetizing method 100 may monetize a game through the use of a digital image that displays and utilizes a product or service integrated into the game from a company. In some embodiments, a first Step 102 may include an administrator creating an online game. The online game may include, without limitation, a poker game, an adventure game, and a sporting game. A Step 104 may include the administrator setting up the game for the player to play. The administrator may include skill levels, designs, languages, or other game variables suitable for different players. A Step 106 may include the administrator agreeing with a company to integrate a product or service into the game. The administrator may monetize the game by charging the company every time the product or service is actuated during the game by the avatar of the player. A Step 108 may include the administrator setting up a virtual store in the game. The virtual store may display virtual products or services available for the player to exchange for at least one credit. The store may provide various information about the product or service, including, without limitation, cost, detailed specs, availability, and company marketing materials.

In one embodiment of the present invention, a Step 110 may include the player logging onto the game. A Step 112 may include the player selecting a game to play from a menu. Each game may be configured to depict a digital image, such as an avatar, acting in representation of the player. A Step 114 may include the player playing the game. The player may play the game for entertainment and to accrue at least one credit. In some embodiments, a Step 116 may include the player accruing the at least one credit by winning at the game. However, in other embodiments, the player may purchase the at least one credit with real money, or barter with other players to accrue the at least one credit. A Step 118 may include the player visiting the virtual store to purchase a product or service for the digital image to utilize. A Step 120 may include the player purchasing the desired product or service for the digital image. A Step 122 may include the product or services appearing with the digital image. The digital image may display or demonstrate the product or service for the player or additional players. For example, without limitation, an avatar may drink a cola purchased with the at least one credit by the player. The brand name of the cola may be prominently displayed by the avatar in a winning pose. In some embodiments, a Step 124 may include the company paying a fee to the game administrator to integrate the company's product or service into the game. In some embodiments, the company may pay a fee for every click or attempt to access the product in the virtual store. However, in another embodiment, the company may pay a fee every time the player views the product or service. For example, without limitation, when the player clicks on a shirt, the administrator may have agreed with a Tommy Bahama shirt company to pay for either a cost per click in which just the Tommy Bahama shirts may be displayed in the store, or a cost per view where the player may click on the desired shirt. In some embodiments, a 5-15 second ad for Tommy Bahama may run in view of the player. In one alternative embodiment, the player may be contacted with email offering additional advertising each time the preselected product is chosen by the player. The email may include a store coupon for Tommy Bahama shirts.

In one embodiment of the present invention, a Step 126 may include the player visiting the game. The player may log onto a free gaming website, choose a game to play, and play the game. In one alternative embodiment, if the player does not have an account with the game, a Step 128 may include the player creating an account. Those skilled in the art, in light of the present teachings, will recognize that creating an account may include the player providing personal information and credit card information. In some embodiments, a Step 130 may include the player logging onto the game to play. If the player does not have a digital image in the form of an avatar, a Step 132 may include the player creating an avatar with a desired set of characteristics and attributes. The player may select from a plurality of attributes including, without limitation, species, gender, hair color, dexterity, speed, intelligence, and charisma. After selecting the desired avatar, a Step 134 may include the player viewing from a variety of games. The games may include, without limitation, a poker game, an adventure game, and a sport game. A Step 136 may include the player selecting the desired game to play from a menu of games. In some embodiments, player information may be collected from the player for future marketing purposes. A Step 138 may include the player playing the game vicariously through the digital image. A Step 140 may include the player earning at least one credit with successful playing of the game. The at least one credit may be accrued through various means, including, without limitation, winning a hand of cards, slaying a dragon, and scoring a goal. In some embodiments, as the player plays the game, certain methods for collecting at least one credit, including, without limitation, frequent player points, loyalty points, and virtual currency may be accrued. The methods for collecting credits may include, but are not limited to, credits being encountered randomly or in specific locations or areas in the game, earning credits for accomplishing a goal such as, but not limited to, completing a level, defeating an enemy, or completing predefined achievements, winning competitions with other human or computer-controlled players, selling items in a store or having other players send the user a gift of credits.

A Step 142 may include the player exiting the game without making any purchases, whereby the player simply plays the game for entertainment. However, in another embodiment, a Step 144 may include the player visiting a virtual store integrated into the game. A Step 146 may include the player purchasing at least one credit. The player may utilize a credit card to purchase the at least one credit. A Step 148 may include the player acquiring the at least one credit through various means, including, without limitation, winning the game, scoring points, bartering with other players, and decreasing the attributes of the digital image. A Step 150 may include the player visiting the virtual store to purchase a product or service for the digital image to utilize. A Step 152 may include the player selecting the product or service to purchase from a menu of products or services. The product or service may include a brand name or logo prominently displayed for the player to view. In some embodiments, the at least one credit may be deducted upon completion of the transaction. A Step 154 may include the player confirming the purchase of the product or service. A Step 156 may include the product or service appearing in a player inventory. The digital image, in the form of an avatar may then have access to the product or service. A Step 158 may include the player exiting the game. A Step 160 may include the player logging off of the online game. In one alternative embodiment of the present invention, the gaming website may include a lottery at intervals such as, but not limited to, hourly, daily, weekly, and monthly. Winning players of the lottery may be awarded a preset amount of credits, or an amount determined by an algorithm. In some embodiments, the lottery may have one or more winners. The lottery may award credits or items from a virtual store.

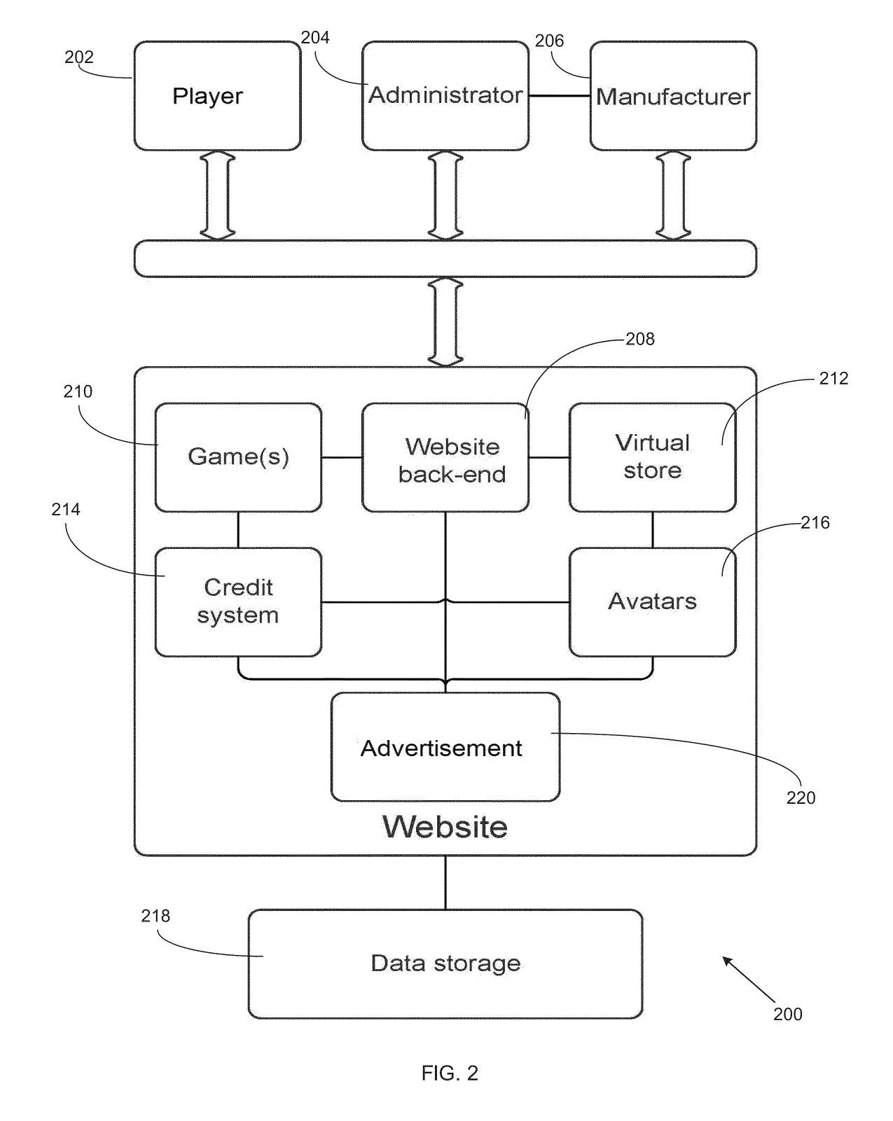

FIG. 2 illustrates an exemplary monetizing system, in accordance with an embodiment of the present invention. In the present invention, system 200, player 202, game administrator 204, and company 206 communicate with website 208. Company 206 may register with game administrator 204 to integrate a product or service into a game 210 through a virtual store 212. The player may accrue at least one credit 214 by successfully playing the game. The player may utilize a digital image 216 for representation during the game. The digital image may include, without limitation an avatar that displays or demonstrates the product or service in the form of an advertisement 220. A data storage site 218 may store registration information pertaining to the product or service, including, without limitation, amount of times product or service displays, amount of credits player accrues, and transfer of monetary funds from the company to the administrator for permission to integrate the products or services into the game. Administrator may transfer information to data storage site. Data storage site may format and store transferred information. A communication server may transfer the information to an external social site.

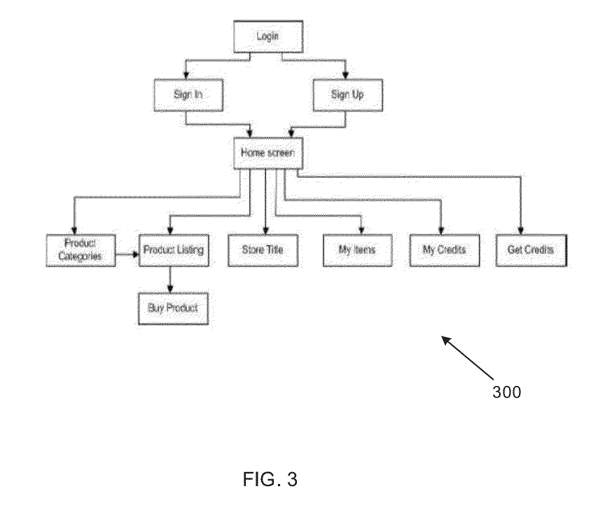

FIG. 3 illustrates a flowchart diagram for an exemplary method for purchasing a product or service with an exemplary at least one credit, in accordance with an embodiment of the present invention. In the present invention, the method for purchasing the product or service 300 may allow the player to purchase the product or service from a virtual store with at least one credit obtained either through playing the game or purchase with monetary funds. However, in other embodiments, the at least one credit may be utilized to update various attributes and characteristics of the avatar. For example, without limitation, ten credits may purchase increased dexterity for an adventure game, or additional charisma for a poker game.

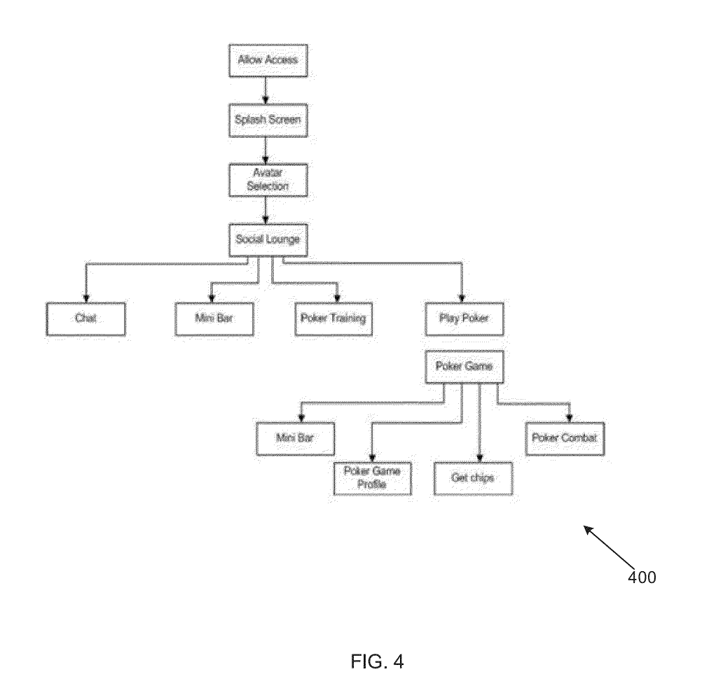

FIG. 4 illustrates a flowchart diagram for an exemplary method for playing an exemplary poker game, in accordance with an embodiment of the present invention. In the present invention, the method for playing an exemplary poker game 400 may provide a forum for the player to play a poker game against the game, or against additional players. In the poker game embodiment, at least one credit may be accrued by the player by betting the at least one credit in a similar manner to how chips or money are traditionally bet in poker. In another embodiment, the at least one credit may accrue automatically in a manner proportional to the number of games played or to the amount of time spent playing the game. The player may then visit the virtual store to purchase the desired product or service.

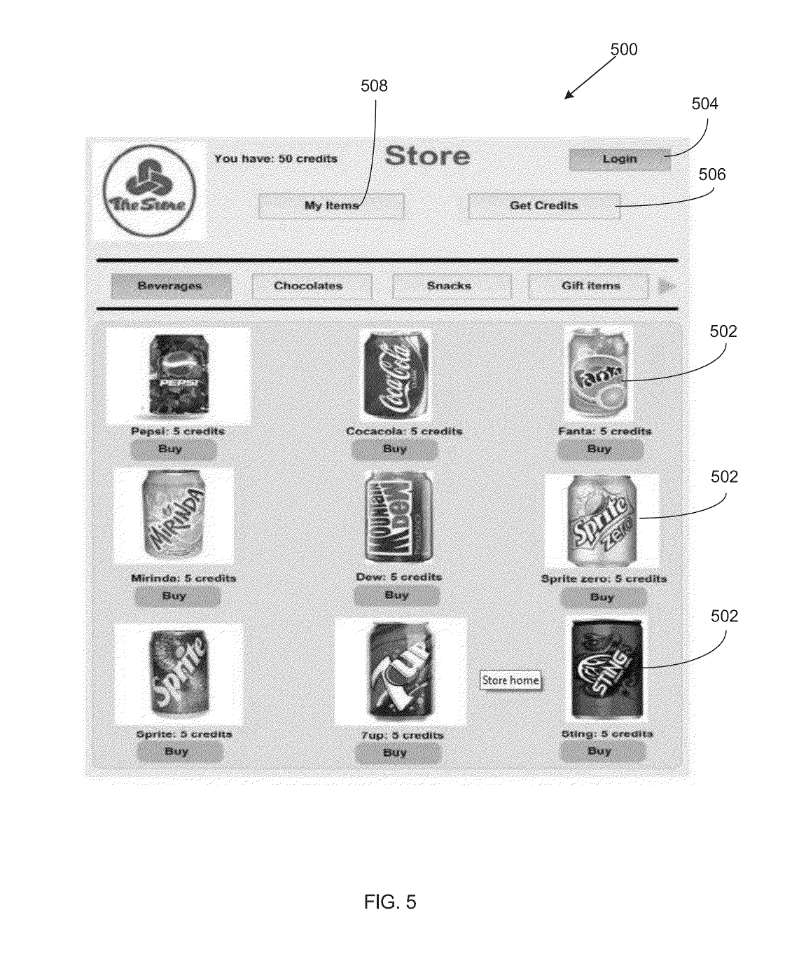

FIG. 5 illustrates an exemplary store that displays an exemplary product or service for purchase, in accordance with an embodiment of the present invention. In the present invention, the store may include a virtual store 500 that displays a plurality of products or services 502 displayed in proximity to each other. In some embodiments, the products or services may include, without limitation, beverages such as soda, juice or alcoholic beverages, cigars, or any other item the website administrator decides to make available. Other examples of products or services may include, without limitation, clothing, logos, hairstyles, or other customizations for the avatar. In some embodiments, each product or service may display next of a similar product. For example, without limitation, colas could be displayed on a graphical menu. The player may then select the cola for the avatar to drink, or to offer another player's avatar. In one embodiment, the store may include a login portion 504, whereby the player may access the store. In one alternative embodiment, the player may utilize a password to access the store. A credit access portion 506 may allow the player to purchase additional credits for purchasing the products or services in the store. A product inventory portion 508 may allow the player to check the inventory of products or services that the player has acquired for the avatar. In this manner, the player may view, purchase, and consolidate products or services while playing the game.

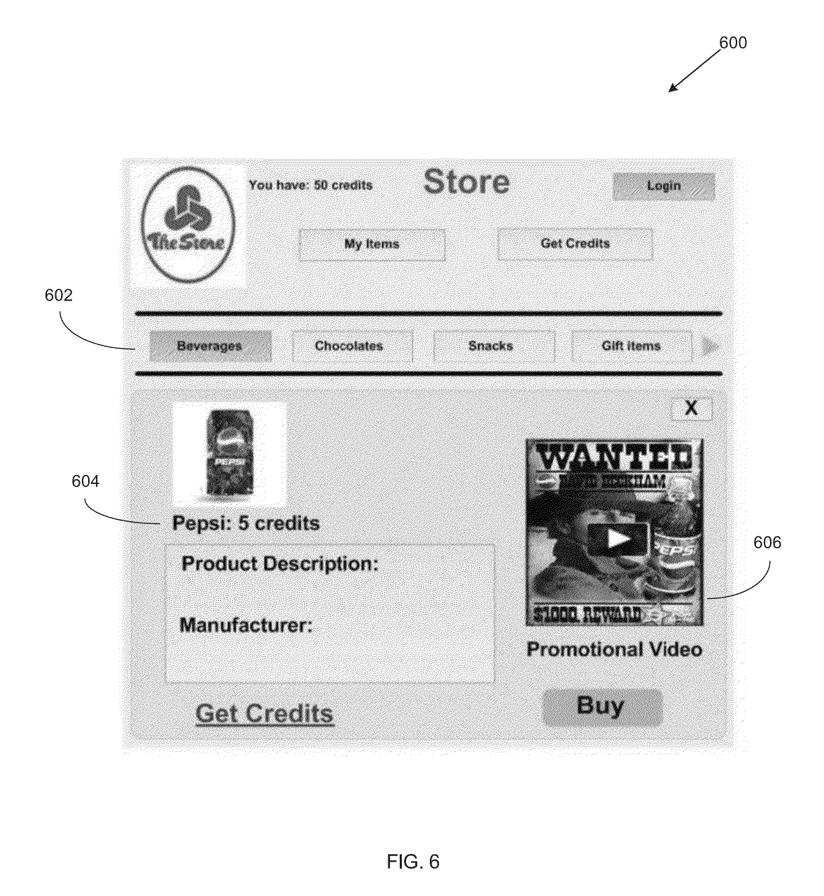

FIG. 6 illustrates an exemplary store that displays information for an exemplary product or service purchased with a at least one credit, in accordance with an embodiment of the present invention. In the present invention, a store 600 may display the products or services of the various companies that signed up with the administrator. In one embodiment, a general products portion 602 in the store may describe the product types, including, without limitation, beverages, chocolates, snacks, and gift items. Upon selecting a general product, a specific menu of that product type may display in the store. A price portion 604 may display the amount of credits necessary to obtain a specific product. A promotional video 606 may then display to encourage the player to select the product or service. In some embodiments, the promotional video may include a five second view of a billboard style advertisement. In another embodiment, the company may pay an additional fee for the promotional video to play for a longer period of time. In this manner, the company may advertise to the player.

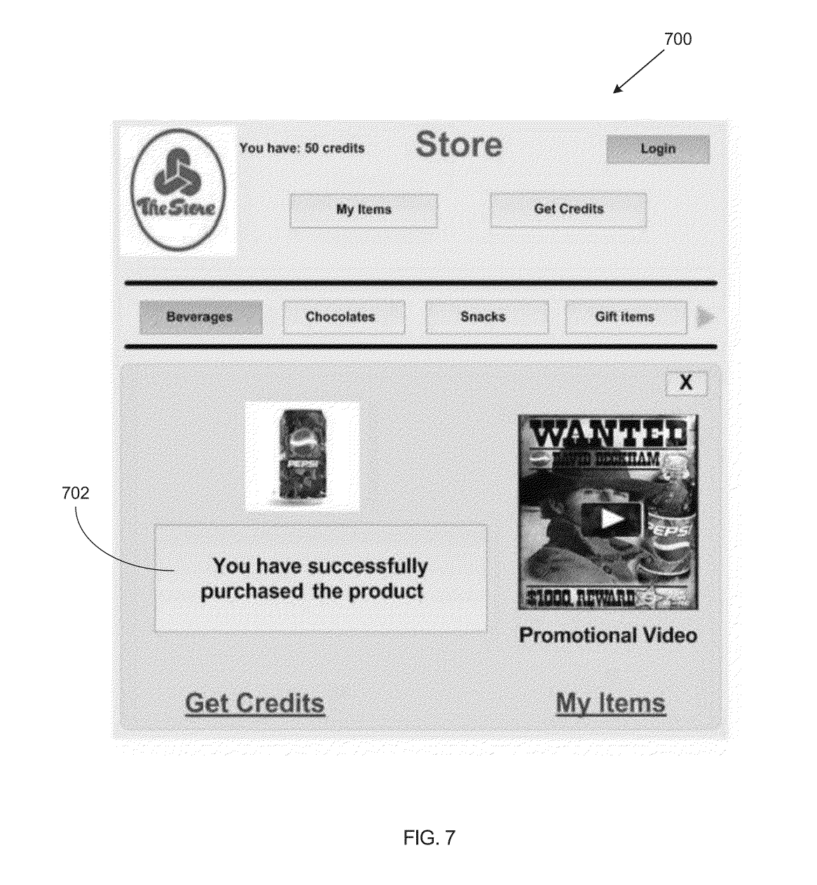

FIG. 7 illustrates an exemplary store that displays an exemplary product or service displayed for potential purchase, in accordance with an embodiment of the present invention. In the present invention, a store 700 may display a specific product or service available for purchase by the player. A purchase indicator portion 702 may indicate when the product or service has been purchased by the player, and how many credits were utilized to obtain the product or service. In some embodiments, the virtual store may display information including, without limitation, the store title and logo, product categories, product names, product prices, product images, product purchase button, products and services the player may have already purchased, the total number of user credits, an option for the player to acquire more credits, and an option for the player to log in to the game. In one embodiment of the present invention, the player may purchase online credits with real money, which may add to the monetization of the gaming website.

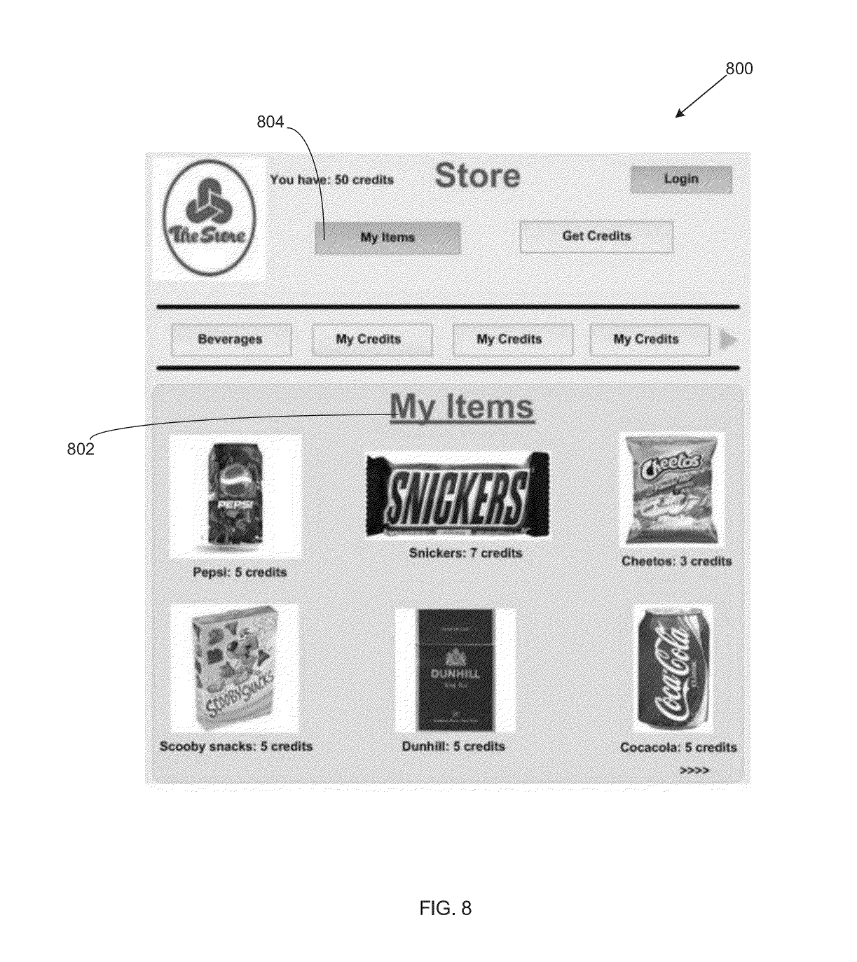

FIG. 8 illustrates an exemplary store that displays an inventory of exemplary products or services purchased by an exemplary player, in accordance with an embodiment of the present invention. In the present invention, a store 800 may display the purchased products or services in an inventory portion 802. A product inventory checkup portion 804 may allow the player to check the inventory of products or services that the player has acquired for a digital image. In this manner, the player may view, purchase, and consolidate products or services while playing the game.

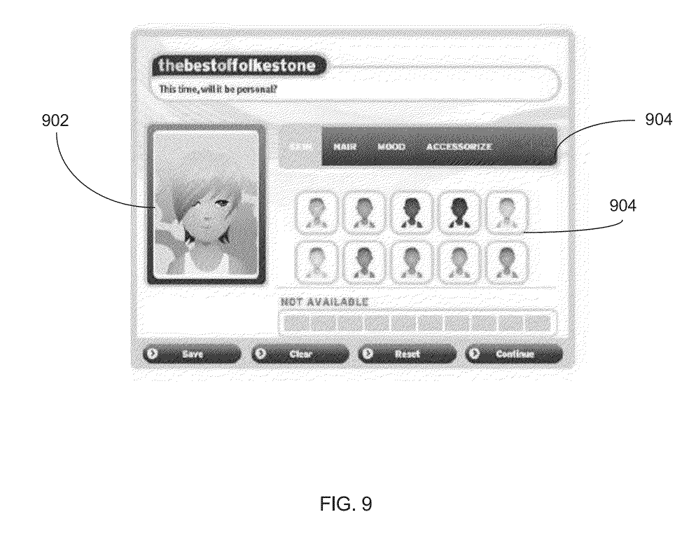

FIG. 9 illustrates an exemplary digital image in the form of an exemplary avatar having a plurality of attributes available for selection, in accordance with an embodiment of the present invention. In the present invention, a player may create a desired digital image 900 for playing the game with. The player may select from a plurality of attributes 902 that represent the player's personality or opinions. The player may create an avatar with a desired set of characteristics and attributes. In some embodiments, the player may select from a plurality of attributes including, without limitation, species, gender, hair color, dexterity, speed, intelligence, and charisma.

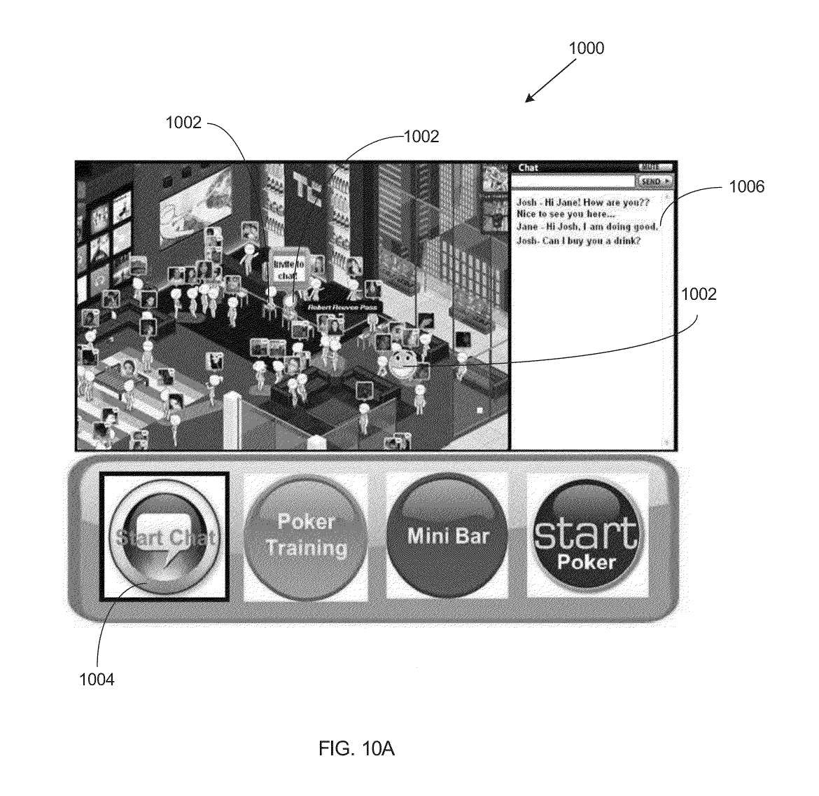

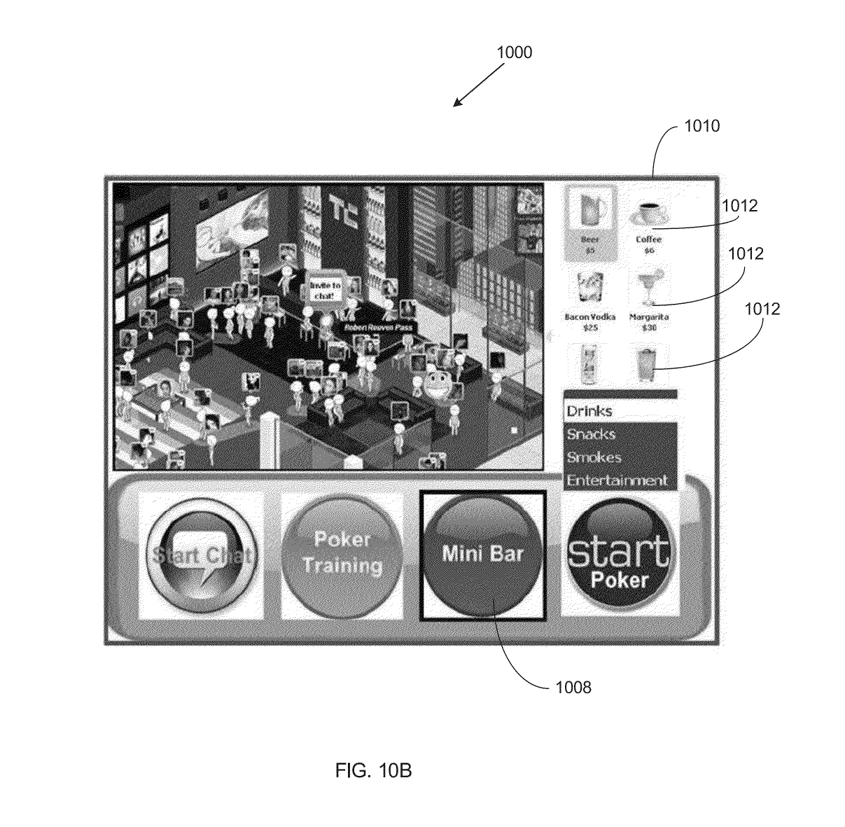

FIGS. 10A and 10B illustrate an exemplary chat room in an exemplary game, in accordance with an embodiment of the present invention, where FIG. 10A illustrates an exemplary player communicating with other exemplary players through exemplary digital images, and FIG. 10B illustrates an exemplary player purchasing a product or service for other exemplary players from an exemplary virtual store. In the present invention, a chat room 1000 may provide a forum for players to communicate about various topics, including, without limitation, socializing, starting new games, dating through the avatar, and obtaining information. A plurality of digital images 1002 may communicate with each other. In some embodiments, the digital image may resemble the avatar that the player created. Those skilled in the art, in light of the present teachings, will recognize that the shape and form of the avatar may allow the player to communicate to other players' specific viewpoints or styles unique to the player. A chat portion 1004 may actuate the chatting between the digital images. A chat display 1006 may display the text of the chat between players. In some embodiments, the player may purchase a product or service for the avatar or other players' avatars. A product selection portion 1008 may allow the player to select the product or service. A store 1010 may display for selecting the desired product or service 1012. The player may then select the product or service and distribute the product or service as desired.

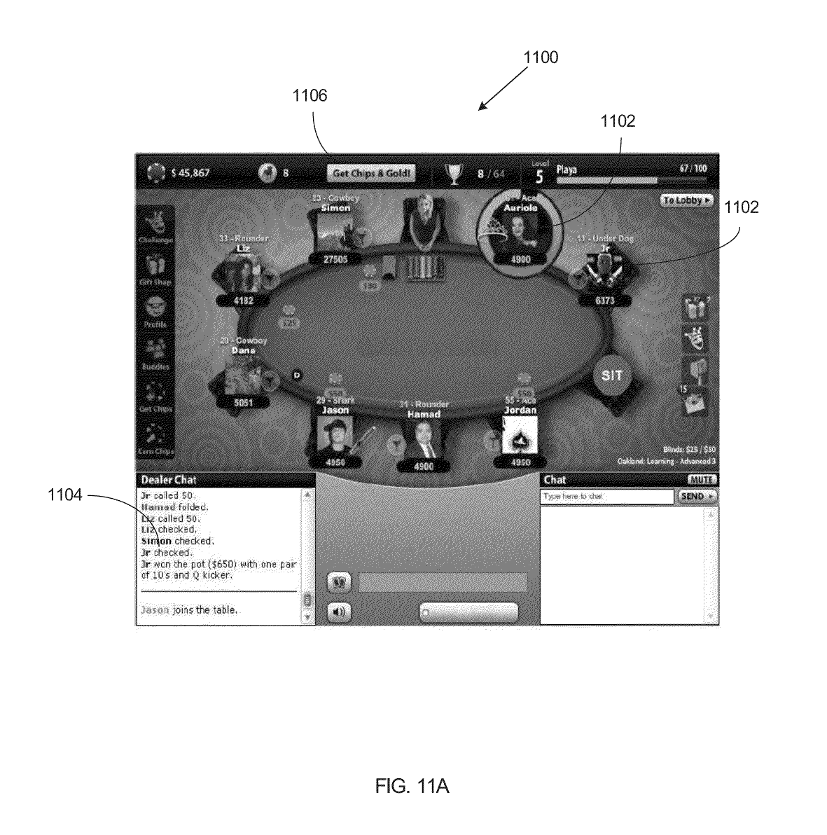

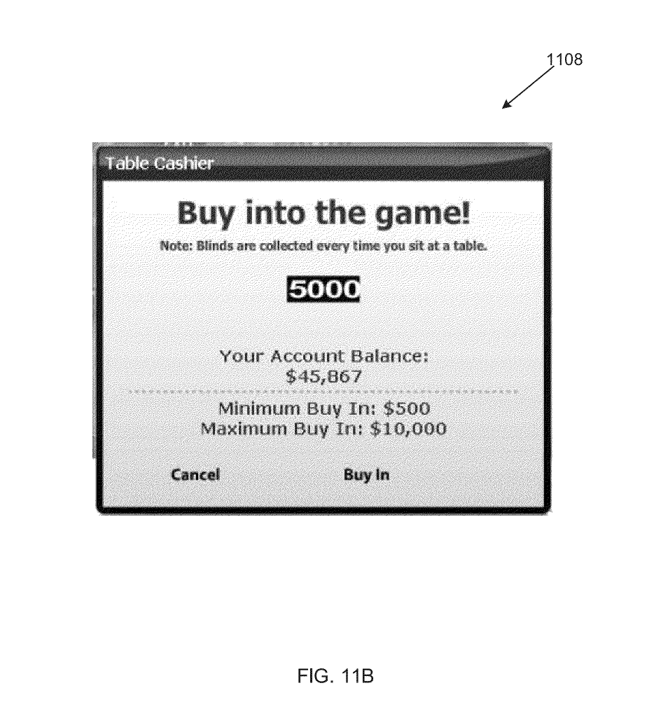

FIGS. 11A and 11B illustrate an exemplary poker game between a plurality of players, in accordance with an embodiment of the present invention, where FIG. 11A illustrates an exemplary graphical depiction of exemplary digital images positioned around a poker table, and FIG. 11B illustrates an exemplary dialogue box inviting the exemplary player to pay an exemplary at least one credit to play the poker game. In the present invention, a plurality of players represented by a plurality of digital images 1102 may play a poker game. The players may position around a digital representation of a poker table. A chat display portion 1104 may allow each player to view comments made by other players during the poker game. A credit access portion 1106 may allow the player to access credits and poker chips for utilizing during the poker game or buying products or services. In some embodiments, a credit tabulation portion 1108 may provide the player with an updated status of the credits or monetary funds available to play the poker game, or won during the poker game. In the poker game embodiment, the at least one credit may be accrued by the player by betting the credits in a similar manner to how chips or money are traditionally bet in poker. In another embodiment, the credits may accrue automatically in a manner proportional to the number of games played or to the amount of time spent playing the game. The player may then visit the virtual store to purchase the desired product or service.

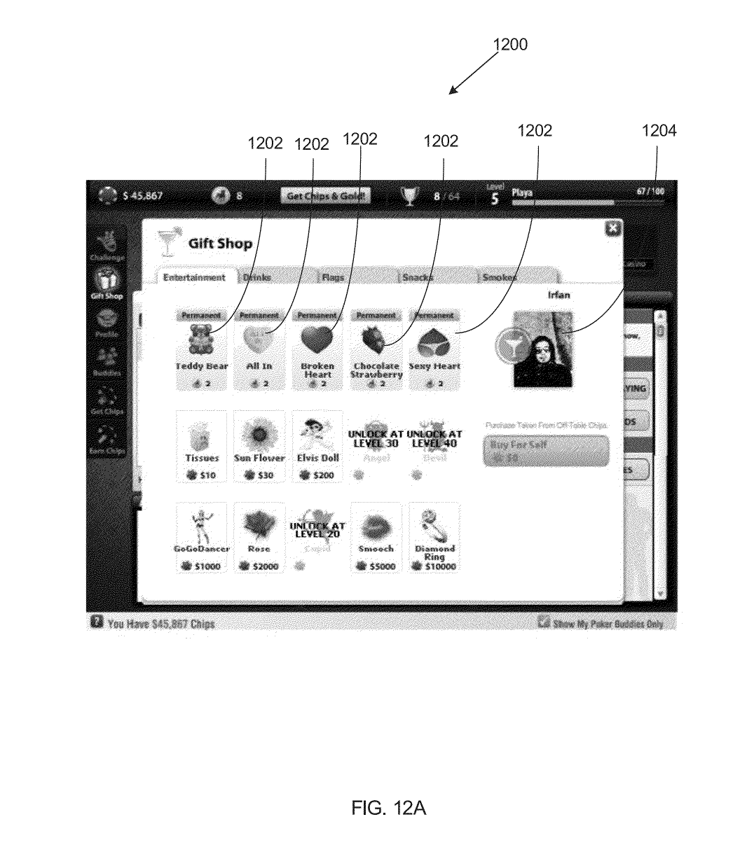

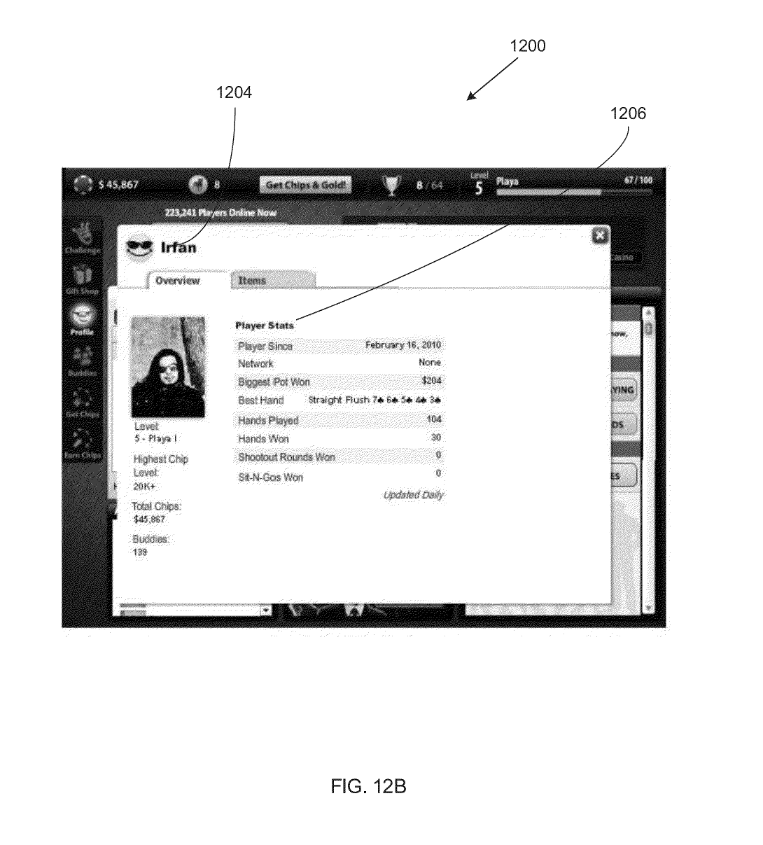

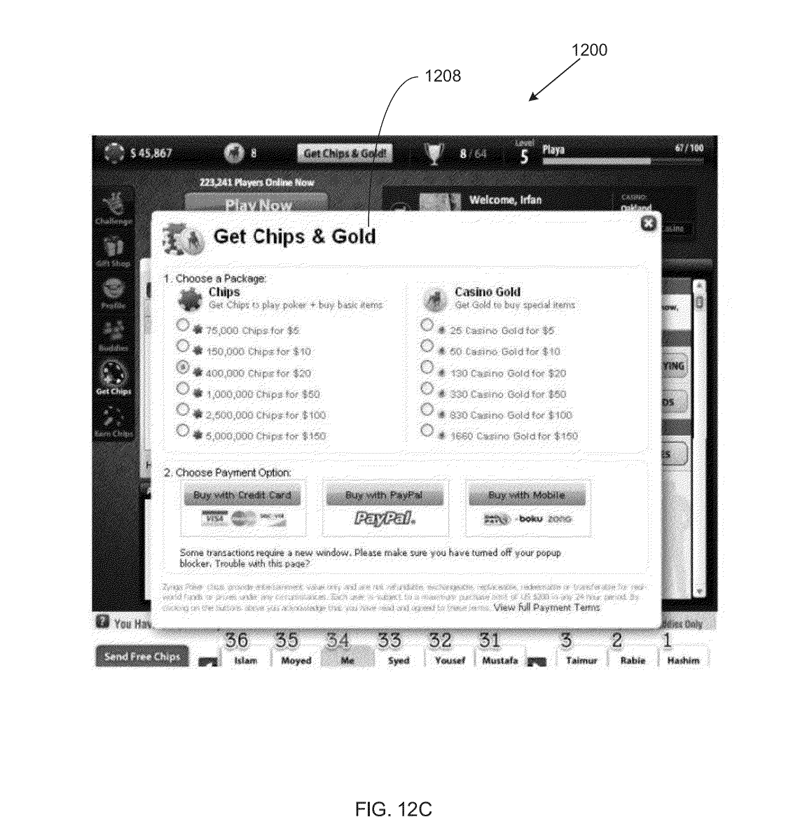

FIGS. 12A, 12B, and 12C illustrate an exemplary poker game between a plurality of players, in accordance with an embodiment of the present invention, where FIG. 12A illustrates an exemplary virtual store displaying a plurality of exemplary products or services, FIG. 12B illustrates an exemplary digital image of an exemplary avatar with exemplary at least one credit and game history, and FIG. 12C illustrates an exemplary dialogue box inviting an exemplary player to purchase a at least one credit to play the poker game. In the present invention, a game status portion 1200 may provide the player information about the status of the game and the status of the player's products or services. The game status portion may include a virtual gift store that displays a plurality of gifts available for purchase for the player's avatar or other players' avatars. In one alternative embodiment, the product or service may be shipped to the player for personal consumption, whereby the product or service is not virtual, but real. In some embodiments, a plurality of products or services 1202 may display in proximity to each other. Each product may display next of a similar product. For example, without limitation, various types of chocolates display on a graphical menu. The player may then select a desired chocolate for the avatar to eat, or to gift another player's avatar. A digital image portion 1204 may display a graphical representation of the player's avatar and attributes of the avatar. A player statistics portion 1206 may list the statistics of the game for the player. The statistics may include, without limitation, the pot won, the best poker hand dealt, the amount of poker hands won, and the date the player joined the network of the game. In some embodiments, a credit access portion 1208 may allow the player to purchase additional credits or poker chips for purchasing the products or services in the store, or play the poker game. In this manner, the player may view, purchase, and consolidate products or services while playing the game.

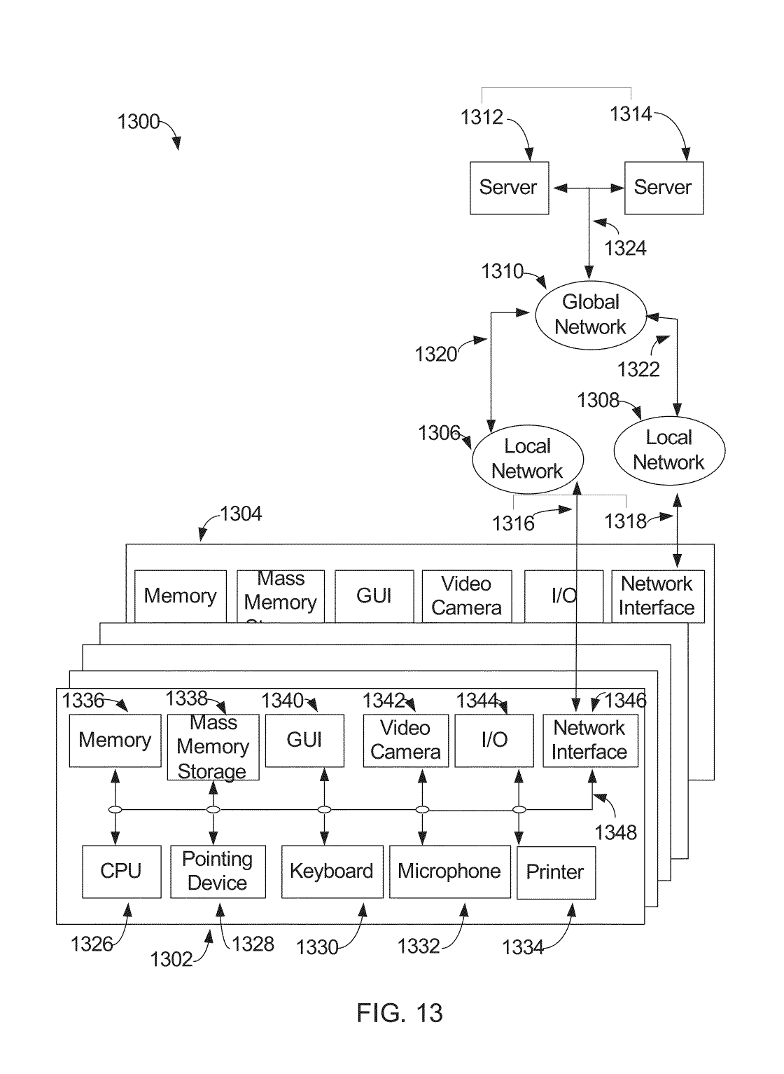

FIG. 13 illustrates a block diagram of an exemplary computer system that, when appropriately configured or designed, may serve as an exemplary monetizing method and system, in accordance with an embodiment of the present invention. In the present invention, a communication system 1300 includes a multiplicity of clients with a sampling of clients denoted as a client 1302 and a client 1304, a multiplicity of local networks with a sampling of networks denoted as a local network 1306 and a local network 1308, a global network 1310 and a multiplicity of servers with a sampling of servers denoted as a server 1312 and a server 1314.

Client 1302 may communicate bi-directionally with local network 1306 via a communication channel 1316. Client 1304 may communicate bi-directionally with local network 1308 via a communication channel 1318. Local network 1306 may communicate bi-directionally with global network 1310 via a communication channel 1320. Local network 1308 may communicate bi-directionally with global network 1310 via a communication channel 1322. Global network 1310 may communicate bi-directionally with server 1312 and server 1314 via a communication channel 1324. Server 1312 and server 1314 may communicate bi-directionally with each other via communication channel 1324. Furthermore, clients 1302, 1304, local networks 1306, 1308, global network 1310 and servers 1312, 1314 may each communicate bi-directionally with each other.

In one embodiment, global network 1310 may operate as the Internet. It will be understood by those skilled in the art that communication system 1300 may take many different forms. Non-limiting examples of forms for communication system 1300 include local area networks (LANs), wide area networks (WANs), wired telephone networks, wireless networks, or any other network supporting data communication between respective entities.

Clients 1302 and 1304 may take many different forms. Non-limiting examples of clients 1302 and 1304 include personal computers, personal digital assistants (PDAs), cellular phones and smartphones.

Client 1302 includes a CPU 1326, a pointing device 1328, a keyboard 1330, a microphone 1332, a printer 1334, a memory 1336, a mass memory storage 1338, a GUI 1340, a video camera 1342, an input/output interface 1344 and a network interface 1346.

CPU 1326, pointing device 1328, keyboard 1330, microphone 1332, printer 1334, memory 1336, mass memory storage 1338, GUI 1340, video camera 1342, input/output interface 1344 and network interface 1346 may communicate in a unidirectional manner or a bi-directional manner with each other via a communication channel 1348. Communication channel 1348 may be configured as a single communication channel or a multiplicity of communication channels.

CPU 1326 may be comprised of a single processor or multiple processors. CPU 1326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 1336 is used typically to transfer data and instructions to CPU 1326 in a bi-directional manner. Memory 1336, as discussed previously, may include any suitable computer-readable media, intended for data storage, such as those described above excluding any wired or wireless transmissions unless specifically noted. Mass memory storage 1338 may also be coupled bi-directionally to CPU 1326 and provides additional data storage capacity and may include any of the computer-readable media described above. Mass memory storage 1338 may be used to store programs, data and the like and is typically a secondary storage medium such as a hard disk. It will be appreciated that the information retained within mass memory storage 1338, may, in appropriate cases, be incorporated in standard fashion as part of memory 1336 as virtual memory.

CPU 1326 may be coupled to GUI 1340. GUI 1340 enables a user to view the operation of computer operating system and software. CPU 1326 may be coupled to pointing device 1328. Non-limiting examples of pointing device 1328 include computer mouse, trackball and touchpad. Pointing device 1328 enables a user with the capability to maneuver a computer cursor about the viewing area of GUI 1340 and select areas or features in the viewing area of GUI 1340. CPU 1326 may be coupled to keyboard 1330. Keyboard 1330 enables a user with the capability to input alphanumeric textual information to CPU 1326. CPU 1326 may be coupled to microphone 1332. Microphone 1332 enables audio produced by a user to be recorded, processed and communicated by CPU 1326. CPU 1326 may be connected to printer 1334. Printer 1334 enables a user with the capability to print information to a sheet of paper. CPU 1326 may be connected to video camera 1342. Video camera 1342 enables video produced or captured by user to be recorded, processed and communicated by CPU 1326.

CPU 1326 may also be coupled to input/output interface 1344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1326 optionally may be coupled to network interface 1346 which enables communication with an external device such as a database or a computer or telecommunications or internet network using an external connection shown generally as communication channel 1316, which may be implemented as a hardwired or wireless communications link using suitable conventional technologies. With such a connection, CPU 1326 might receive information from the network, or might output information to a network in the course of performing the method steps described in the teachings of the present invention.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing monetization of an online game through an avatar who displays and demonstrates a company's product or service during the game according to the present invention will be apparent to those skilled in the art. Various aspects of the invention have been described above by way of illustration, and the specific embodiments disclosed are not intended to limit the invention to the particular forms disclosed. The particular implementation of the online game through an avatar that displays and demonstrates a company's product or service during the game may vary depending upon the particular context or application. By way of example, and not limitation, the online game through an avatar who displays and demonstrates a company's product or service during the game described in the foregoing were principally directed to a game administrator that charges companies a fee to integrate products or services into a game for viewing by a player implementations; however, similar techniques may instead be applied to marketing products or services through the use of word processing software at work sites, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. One or more computer storage media storing computer-usable instructions, that when used by one or more computing devices, cause the one or more computing devices to perform a method comprising the steps of:
(a) playing a game, by a player, at last partially through a digital image;
(b) earning at least one credit, at least partially for winning said game;
(c) accessing a store;
(d) purchasing a product and/or service from said store, at least partially with said at least one credit; and
(e) displaying said product and/or service in proximity to said digital image, at least partially during said game.

2. The method of claim 1, in which said playing a game step in (a) further comprises the step of playing a poker game.

3. The method of claim 2, in which said playing a game step in (a) further comprises the step of playing a poker game as an avatar.

4. The method of claim 3, in which said playing a game step in (a) further comprises the step of collecting at least one player information from a player.

5. The method of claim 1, in which said earning at least one credit step in (b) further comprises the step of earning at least one credit, at least partially by purchasing said at least one credit with monetary funds.

6. The method of claim 5, in which said earning at least one credit step in (b) further comprises the step of earning at least one credit, at least partially by bartering with at least one player.

7. The method of claim 6, in which said earning at least one conflict credit, at least partially for winning said game step in (b) further comprises the step of obtaining a winning poker hand.

8. The method of claim 1, in which said accessing a store step in (d)(c) further comprises the step of at least partially accessing a virtual store.

9. The method of claim 8, in which said accessing a store step in (d)(c) further comprises the step of at least partially including said virtual store in said game for displaying and/or selling said product and/or service.

10. The method of claim 1, in which said purchasing a product and/or service from said store, at least partially with said at least one credit step in (d) further comprises the step of purchasing said product and/or service, at least partially for said digital image.

11. The method of claim 10, in which said purchasing a product and/or service from said store, at least partially with said at least one credit step in (d) further comprises the step of enhancing said digital image with said product and/or service.

12. The method of claim 11, in which said purchasing a product and/or service from said store, at least partially with said at least one credit step in (d) further comprises the step of a company integrating said product and/or service into said store.

13. The method of claim 12, in which said purchasing a product and/or service from said store, at least partially with said at least one credit step in (d) further comprises the step of charging said company an advertising monetary fee for integrating said product and/or service into said store.

14. The method of claim 13, in which said purchasing a product and/or service from said store, at least partially with said at least one credit step in (d) further comprises the step of displaying an advertisement for said product and/or service, at least partially based on said advertising monetary fee.

15. The method of claim 14, in which said purchasing a product and/or service from said store, at least partially with said at least one credit step in (d) further comprises the step of displaying said advertisement, said advertisement comprising a billboard advertisement.

16. The method of claim 15, in which said purchasing a product and/or service from said store, at least partially with said at least one credit step in (d) further comprises the step of said company obtaining said at least one player information.

17. The method of claim 16, in which said purchasing a product and/or service from said store, at least partially with said at least one credit step in (d) further comprises the step of said company contacting said player with said advertisement and/or a plurality of marketing media.

18. The method of claim 1, in which said displaying said product and/or service in proximity to said digital image step in (e) further comprises the step of said digital image, at least partially, displaying and/or utilizing said product and/or service while playing said game.

19. A system for monetizing conflicts comprising:
means for playing a game, by a player, at last partially through a digital image;
means for earning at least one credit, at least partially for winning said game;
means for accessing a store;
means for purchasing a product and/or service from said store, at least partially with said at least one credit; and
means for displaying said product and/or service in proximity to said digital image, at least partially during said game.

20. A non-transitory program storage device readable by a machine tangibly embodying a program of instructions executable by the machine to perform a method for monetizing conflicts, the storage device comprising:
(a) computer code for playing a game, by a player, at last partially through a digital image, said game comprising a poker game, said playing a game step in (a) further comprising the step of playing a poker game as an avatar, said playing a game step in (a) further comprising the step of collecting at least one player information from a player;
(b) computer code for earning at least one credit, at least partially for winning said game, said earning at least one credit step in (b) further comprising the step of earning at least one credit, at least partially by purchasing said at least one credit with monetary funds, said earning at least one credit step in (b) further comprising the step of earning at least one credit, at least partially by bartering with at least one player;
(c) computer code for accessing a store, said accessing a store step in (d)(c) further comprising the step of at least partially accessing a virtual store, said accessing a store step in (d)(c) further comprising the step of at least partially including said virtual store in said game for displaying and/or selling said product and/or service;
(d) computer code for purchasing a product and/or service from said store, at least partially with said at least one credit, said purchasing a product and/or service from said store, at least partially with said at least one credit step in (d) further comprising the step of purchasing said product and/or service, at least partially for said digital image, said purchasing a product and/or service from said store, at least partially with said at least one credit step in (d) further comprising the step of enhancing said digital image with said product and/or service, said purchasing a product and/or service from said store, at least partially with said at least one credit step in (d) further comprising the step of a company integrating said product and/or service into said store, said purchasing a product and/or service from said store, at least partially with said at least one credit step in (d) further comprising the step of charging said company an advertising monetary fee for integrating said product and/or service into said store, said purchasing a product and/or service from said store, at least partially with said at least one credit step in (d) further comprising the step of displaying an advertisement for said product and/or service, at least partially based on said advertising monetary fee, said purchasing a product and/or service from said store, at least partially with said at least one credit step in (d) further comprising the step of displaying said advertisement, said advertisement comprising a billboard advertisement, said purchasing a product and/or service from said store, at least partially with said at least one credit step in (d) further comprising the step of said company obtaining said at least one player information, said purchasing a product and/or service from said store, at least partially with said at least one credit step in (d) further comprising the step of said company contacting said player with said advertisement and/or a plurality of marketing media; and
(e) computer code for displaying said product and/or service in proximity to said digital image, at least partially during said game, said displaying said product and/or service in proximity to said digital image step in (e) further comprising the step of said digital image, at least partially, displaying and/or utilizing said product and/or service while playing said game.
